(19) United States
(12) Patent Application Publication
(10) Pub. No.: US 2015/0181862 A1
(43) Pub. Date: Jul. 2, 2015

(54) AGRICULTURAL PESTICIDE COMPOSITIONS

(71) Applicant: RHODIA OPERATIONS, Paris (FR)

(72) Inventors: Rajesh GOYAL, Bensalem, PA (US); Krish SHANMUGA, Plainsboro, NJ (US); Stephen L. WILSON, Zionsville, IN (US)

(73) Assignee: RHODIA OPERATIONS, Paris (FR)

(21) Appl. No.: 14/585,440

(22) Filed: Dec. 30, 2014

Related U.S. Application Data
(60) Provisional application No. 61/921,629, filed on Dec. 30, 2013.

(51) Int. Cl. A01N 25/04; A01N 39/04; A01N 57/20; A01M 25/00; A01M 21/00

(52) U.S. Cl. CPC A01N 25/04; A01M 25/006; A01M 21/00; A01N 57/20; A01N 39/04

(57) ABSTRACT

An adjuvant composition for modifying the spray properties of an aqueous pesticide composition contains at least one fatty alcohol having a solubility in water of less than 10 percent by weight, in an amount that is effective, when the adjuvant composition is diluted in the aqueous pesticide composition and the aqueous pesticide composition is spray applied, as a drift control agent for the spray applied aqueous pesticide composition and at least one of a liquid medium, one or more hydrotropes, or one or more surfactants, a concentrated pesticide composition contains a liquid medium, one or more pesticide compounds, and at least one such fatty alcohol, in an amount that is effective, when the concentrated pesticide composition is diluted to form an aqueous pesticide composition and the aqueous pesticide composition is spray applied, as a drift control agent for the spray applied aqueous pesticide composition an end use pesticide composition contains water, a pesticide, and at least one such fatty alcohol in an amount that is effective, when the aqueous pesticide composition is spray applied, as a drift control agent for the spray applied aqueous pesticide composition, and a method for controlling spray drift of an aqueous pesticide composition includes the steps of incorporating in the aqueous spray composition an amount effective of at least one such fatty alcohol that is effective, when the aqueous pesticide composition is spray applied, as a drift control agent for the spray applied aqueous pesticide composition, and spray applying the pesticide composition to a target pest and/or to the environment of the target pest.

### CROSS REFERENCE TO RELATED APPLICATIONS

This application claims the benefit of U.S. Provisional Application No. 61/921,629, filed on Dec. 30, 2013, hereby incorporated by reference.

### FIELD OF THE INVENTION

This invention relates to agricultural pesticide compositions.

### BACKGROUND OF THE INVENTION

Many agricultural pesticides, including insecticides, fungicides, herbicides, miticides, and plant growth regulators, are applied in the form of a liquid composition. In addition to the pesticide, such liquid compositions typically include one or more adjuvant compounds intended to improve one or more properties of the liquid composition, such as for example, storage stability, ease of handling, and/or pesticide efficacy against target organisms.

There has been an interest in reducing drift, that is, reducing off-target movement of spray droplets, of spray applied pesticides. The addition of high molecular weight water soluble polymers to spray compositions as a tank mix to increase droplet size and thereby reduce drift of spray applied pesticides in known, see, for example, U.S. Pat. No. 5,874,096 and U.S. Pat. No. 6,214,771. Such polymeric drift control additives tend to perform best within a relatively narrow range of concentration, for example, in spray compositions comprising from about 0.05 to 0.15 percent by weight of such polymer.

There is a continuing interest in developing adjuvants for controlling drift of spray applied pesticides that exhibit high performance when present in a spray composition in low amount and that are relatively insensitive to the amount of adjuvant in the spray composition.

### SUMMARY OF THE INVENTION

In a first aspect, the present invention is directed to an adjuvant composition for modifying the spray properties of an aqueous pesticide composition, comprising:

at least one fatty alcohol having a solubility in water of less than 10 percent by weight, in an amount that is effective, when the adjuvant composition is diluted in the aqueous pesticide composition and the aqueous pesticide composition is spray applied, to reduce spray drift of the spray applied aqueous pesticide composition compared to an analogous spray applied pesticide composition that lacks the at least one fatty alcohol, and at least one of:

a liquid medium,
one or more hydrotropes, or
one or more surfactants.

In a second aspect, the present invention is directed to a concentrated pesticide composition, comprising:

a liquid medium,

one or more pesticide compounds, and

at least one fatty alcohol having a solubility in water of less than 10 percent by weight, in an amount that is effective, when the concentrated pesticide composition is diluted and spray applied, to reduce spray drift of the spray applied pesticide composition.

In a third aspect, the present invention is directed to an end use pesticide composition, comprising:
water,
one or more pesticide compounds, and
at least one fatty alcohol having a solubility in water of less than 10 percent by weight, in an amount that is effective, when the end use pesticide composition is spray applied, to reduce spray drift of the spray applied pesticide composition compared to an analogous spray applied pesticide composition that lacks the at least one fatty alcohol.

In a fourth aspect, the present invention is directed to a method for controlling spray drift of an aqueous pesticide composition that comprises one or more pesticide compounds and water, said method comprising:

incorporating in the aqueous pesticide composition, in an amount effective as a drift control agent, at least one fatty alcohol having a solubility in water of less than 10 percent by weight in an amount that is effective, when the end use pesticide composition is spray applied, to reduce spray drift of the spray applied pesticide composition compared to an analogous spray applied pesticide composition that lacks the at least one fatty alcohol, and

spray applying the aqueous pesticide composition to a target pest and/or to the environment of the target pest.

The drift control performance of the spray composition comprising the fatty alcohol drift control agent is less sensitive to concentration than a high molecular weight polymeric drift control agent and has a less dramatic effect on the viscosity of the pesticide composition than a high molecular weight polymeric drift control agent. Compared to analogous spray compositions that lack a drift control agent, spray compositions comprising a high molecular weight drift control agent and spray compositions comprising the fatty alcohol drift control agent each tend to exhibit fewer small droplets having a size of less than 150 μm, and compared to an analogous spray compositions comprising a high molecular weight polymeric drift control agent, spray compositions comprising the fatty alcohol drift control agent tend to exhibit fewer large droplets having a size of greater than 500 μm, with the net result being that compared to analogous spray compositions that either lack a drift control agent or include a high molecular weight polymeric drift control agent, spray compositions comprising the fatty alcohol drift control agent tend to exhibit relatively more droplets within the highly desirable size range of from 150-500 μm. Compared to spray application of analogous spray compositions that lack a drift control agent, spray application of spray compositions that comprise a high molecular weight polymeric drift control agent through a spray nozzle tend to exhibit a decrease in the angle of the spray exiting the spray nozzle and thus a narrower spray pattern at a given distance from the nozzle. Another advantage of the fatty alcohol drift control agent is that compared to spray application of spray compositions that comprise a high molecular weight polymeric drift control agent, spray application of spray compositions that comprise a fatty alcohol drift control agent tend not to exhibit as great a decrease in spray angle and therefore tend to exhibit a wider spray pattern at a given distance from the spray nozzle.

### DETAILED DESCRIPTION OF INVENTION AND PREFERRED EMBODIMENTS

As used herein, the term “alkyl” means a saturated straight chain, branched chain or cyclic hydrocarbon radical, such as for example, methyl, ethyl, n-propyl, iso-propyl, n-butyl, sec-butyl, t-butyl, pentyl, n-hexyl, cyclohexyl, which, in the case of cyclic alkyl groups, may be further substituted on one or more carbon atoms of the ring with a straight chain or branched alkyl group and wherein any two of such substituents may be fused to form a polyalkylene group that bridges the two ring carbon atoms to which they are attached.

As used herein, the term “alkyldienyl” means a saturated linear or branched diradical, such as for example, —CH2-CH₂—CH₂—,

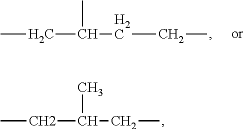

and the term “alkyltrienyl” means a saturated linear or branched triradical such as for example,

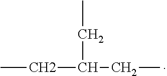

As used herein, the term “alkoxyl” means an oxy group substituted with an alkyl group, such as, for example, methoxyl, ethoxyl, and propoxyl.

As used herein, the term “hydroxyalkyl” means a saturated straight chain or branched chain hydrocarbon radical substituted one or more carbon atoms with a hydroxyl group, such as for example, hydroxymethyl, hydroxyethyl, hydroxypropyl.

As used herein, the term “alkenyl” means an unsaturated straight chain, branched chain, or cyclic hydrocarbon radical that contains one or more carbon-carbon double bonds, such as, for example, ethenyl, 1-propenyl, and 2-propenyl, cyclohexenyl, which, in the case of cyclic alkenyl groups, may be further substituted on one or more carbon atoms of the ring with a straight chain or branched alkyl group and wherein any two of such substituents may be fused to form a polyalkylene group that bridges the two ring carbon atoms to which they are attached.

As used herein, the term “aryl” or “aromatic” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, such as, for example, phenoxy, phenyl, methylphenyl, dimethylphenyl, trimethylphenyl, chlorophenyl, trichloromethylphenyl, aminophenyl, and tristyrylphenyl.

As used herein, the term “alkenyldienyl” means an unsaturated linear or branched diradical, such as, for example,

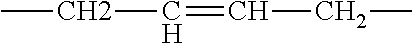

and the term “alkenyltrienyl” means an unsaturated linear or branched triradical, such as for example,

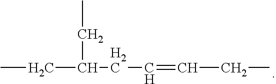

As used herein, the term “aralkyl” means an alkyl group substituted with one or more aryl groups, such as, for example, phenylmethyl, phenylethyl, and triphenylmethyl.

As used herein, the term “alkylaromatic” means an aromatic group substituted with one or more linear, branched or cyclic alkyl groups, such as, for example, methylphenyl, and ethylphenyl.

As used herein, the terminology “(Cₘ-Cₙ)” in reference to an organic group, wherein m and n are each integers, indicates that the group may contain from m carbon atoms to n carbon atoms per group.

As used herein, the term “agronomically acceptable salts” refers to salts prepared from agronomically acceptable non-toxic bases or acids including inorganic or organic bases and inorganic or organic acids. Typical agronomically acceptable salts the compound referred to herein comprise an anion derived from the compound, for example, by deprotonation of a hydroxy or hydroxyalkyl substituent, and one or more positively charged counterions. Suitable positively charged counterions include inorganic cations and organic cations, such as for example, sodium cations, potassium cations, calcium cations, magnesium cations, isopropylamine cations, ammonium cations, and tetraalkylammonium cations.

As used herein, the terminology “end use pesticide composition” means an aqueous pesticide composition that contains pesticide in amount effective to control a target pest, such as, for example, a target plant, fungus, bacterium, or insect, when the end use pesticide composition is applied, typically in the form of an spray, to the pest and/or to the environment of the pest at a given application rate and the terminology “concentrated pesticide composition” means a composition that contains a relatively high concentration of pesticide that is suitable to be diluted with water to form a end use pesticide composition.

As used herein, the terminology “effective amount” in reference to the relative amount of a pesticide in a pesticide composition means the relative amount of pesticide that is effective to control a target pest, for example, a target plant, fungus, bacterium, or insect, when the pesticide composition is applied to the pest and/or to the environment of the pest at a given application rate and the terminology “herbicidally effective amount” in reference to the relative amount of herbicide in an herbicidal composition means the relative amount that is effective to control growth of a target plant when the herbicidal composition is spray applied to the target plant and/or to the environment of the plant at a given application rate.

As used herein, the term “drift” refers to off-target movement of droplets of a pesticide composition that is applied to a target pest or environment for the pest. Spray applied compositions typically exhibit decreasing tendency to drift with decreasing relative amount, typically expressed as a volume percentage of total spray applied droplet volume, of small size spray droplets, that is, spray droplets having a droplet size below a given value, typically, a droplet size of less than 150 micrometers (“μm”). Spray drift of pesticides can have undesirable consequences, such as for example, unintended contact of phytotoxic pesticides with non-pest plants, such as crops or ornamental plants, with damage to such non-pest plants.

As used herein, the terminology “an amount effective to reduce spray drift” in reference to the fatty alcohol drift control agent of the present invention means an amount of such fatty alcohol drift control agent that, when added to a given aqueous pesticide composition and the combined aqueous pesticide composition and fatty alcohol drift control agent is spray applied, is effective to reduce spray drift of the spray applied composition compared to an analogous spray applied pesticide composition that lacks the at least one fatty alcohol that is spray applied under the same conditions. Typically, the ability of a given amount of fatty alcohol drift control agent to reduce spray drift of a spray applied composition is evaluated by spray applying, under the same spray conditions, a pesticide composition that contains the given amount of the fatty alcohol drift control agent and an analogous pesticide composition that lacks the fatty alcohol drift control agent and then comparing the relative amount of small size spray droplets exhibited by spray applied compositions, with a reduction in the amount of small size spray droplets being indicative of the ability to reduce spray drift of the spray applied composition.

As used herein, “liquid medium” means a medium that is in the liquid phase at a temperature of 25° C. and a pressure of one atmosphere. The liquid medium may be a non-aqueous liquid medium or an aqueous liquid medium.

In one embodiment, the liquid medium is a non-aqueous liquid medium. As used herein, the terminology “non-aqueous medium” means a single phase liquid medium that contains no more than trace amounts of water, typically, based on 100 parts by weight (“pbw”) of the non-aqueous medium, no more than 0.1 pbw water. Suitable non-aqueous liquid media include organic liquids, including non-polar organic liquids, such as benzene, chloroform, and diethyl ether, polar aprotic organic liquids, such as dichloromethane, ethyl acetate, acetone, and tetrahydrofuran, and polar protic organic liquids, such as (C₁-C₃)alkanols and (C₁-C₃)polyols, such as methanol, ethanol, and propanol, glycerol, ethylene glycol, propylene glycol, diethylene glycol, poly(ethylene glycol)s, ethylene glycol monobutyl ether, dipropylene glycol methyl ether, and ethylene glycol phenyl ether, as well as mixtures of such liquids. In one embodiment, the non-aqueous medium comprises an organic liquid that is not miscible with water (a “water immiscible organic liquid”), such as, for example, fatty acid esters and alkylated fatty acid esters. Suitable fatty acid esters include alkyl or hydroxyalkyl esters of (C₁₂-C₂₂)carboxylic acids, such as butyl myristate, cetyl palmitate, decyloleate, glyceryl laurate, glyceryl ricinoleate, glyceryl stearate, glyceryl isostearate, hexyl laurate, isobutyl palmitate, isocetyl stearate, isopropyl isostearate, isopropyl laurate, isopropyl linoleate, isopropyl myristate, isopropyl palmitate, isopropyl stearate, propylene glycol monolaurate, propylene glycol ricinoleate, propylene glycol stearate, and propylene glycol isostearate, and mixtures thereof, including (C₁-C₃)alkylated esters of (C₁₂-C₂₂)carboxylic acids, such as methylated rapeseed oil and methylated soybean oil.

In one embodiment, the liquid medium is an aqueous liquid medium. As used herein, the terminology “aqueous medium” means a single phase liquid medium that contains more than a trace amount of water, typically, based on 100 pbw of the aqueous medium, more than 0.1 pbw water. Suitable aqueous media more typically comprise, based on 100 pbw of the aqueous medium, greater than about 5 pbw water, even more typically greater than 10 pbw water. In one embodiment, the aqueous emulsion comprises, based on 100 pbw of the aqueous medium, greater than 40 pbw water, more typically, greater than 50 pbw water. The aqueous medium may, optionally, further comprise water soluble or water miscible components dissolved in the aqueous medium. The terminology “water miscible” as used herein means miscible in all proportions with water. Suitable water miscible organic liquids include, for example, (C₁-C₃)alcohols, such as methanol, ethanol, and propanol, and (C₁-C₃)polyols, such as glycerol, ethylene glycol, and propylene glycol. The composition of the present invention may, optionally, further comprise one or more water insoluble or water immiscible components, such as a water immiscible organic liquid, wherein the combined aqueous medium and water insoluble or water immiscible components form a micro emulsion, or a multi-phase system such as, for example, an emulsion, a suspension or a suspo-emulsion, in which the aqueous medium is in the form of a discontinuous phase dispersed in a continuous phase of the water insoluble or water immiscible component, or, more typically, the water insoluble or water immiscible component is in the form of a discontinuous phase dispersed in a continuous phase of the aqueous medium.

Fatty alcohols suitable as the fatty alcohol drift control agent of the present invention are those that have a limited solubility in a given liquid medium selected from water and aqueous pesticide compositions, more typically a solubility of less than 15%, or less than 10%, or less than 5%, or less than 2%, or less than 1%, or less than 0.5%, or less than 0.1%, in the liquid medium. As referred to herein the terminology “having a solubility of less than x %”, where x is a number, in reference to a surfactant in a given liquid medium means that a mixture of x % by weight of the surfactant compound the liquid medium forms two macroscopic phases or forms a single macroscopic phase having a turbidity greater than or equal to 10 nephelometric turbidity units (“NTU”), or greater than or equal to 5 NTU, or greater than or equal to 1 NTU, or greater than or equal to 0 NTU, as determined by using a nephelometer, such as for example, a 2100P Turbidimeter (VWR).

In one embodiment, the amount of fatty alcohol drift control agent in a given end use pesticide composition is an amount that is greater than the solubility limit of that compound in that end use pesticide composition. As referred to herein, the terminology “having a solubility limit of greater than y %” where y is a number, in reference to a surfactant in a given pesticide composition means that a mixture of less than or equal to y % by weight of the surfactant compound the pesticide composition forms a macroscopically single phase, non-turbid mixture and a mixture of greater than y % by weight of the surfactant compound the pesticide composition forms two macroscopic phases or forms a single macroscopic phase having a turbidity greater than or equal to 10 NTU, or greater than or equal to 5 NTU, or greater than or equal to 1 NTU, or greater than or equal to 0 NTU, as determined by using a nephelometer.

In one embodiment, the fatty alcohol drift control agent comprises one or more fatty alcohols.

In one embodiment, the fatty alcohol drift control agent of the present invention comprises one or more fatty alcohols according to structure (I):

R¹—OH (I)

wherein:
R¹ is a (C₄-C₃₀)hydrocarbyl group or a (C₄-C₃₀)hydrocarbyl substituted with one or more hydroxyl groups.

In one embodiment, the (C₄-C₃₀)hydrocarbyl is substituted with 1, 2 or 3 hydroxyl groups. In one embodiment, the (C₄-C₃₀)hydrocarbyl group, or (C₄-C₃₀)hydrocarbyl group substituted with one or more hydroxyl groups, is an alkyl, alkylaromatic, aralkyl, or cycloalkyl, any of which having a linear or branched alkyl group.

In one embodiment, the (C₄-C₃₀)hydrocarbyl group or (C₄-C₃₀)hydrocarbyl group substituted with one or more hydroxyl groups is a linear or branched (C₄-C₃₀)alkyl, more typically (C₈-C₂₄)alkyl, (C₆-C₁₂)cycloalkyl, linear or branched (C₄-C₃₀)alkenyl, more typically (C₈-C₂₄)alkenyl, (C₈-C₃₀)alkylaromatic, or (C₇-C₃₀)aralkyl, more typically (C₈-C₃₀)aralkyl, and n is 1, wherein the alkenyl groups may be monounsaturated or polyunsaturated.

Alkyl groups suitable as the R¹ substituent of the compound of formula (I) include, for example, pentyl, hexyl, dimethylbutyl, heptyl, methylhexyl, octyl, ethylhexyl, nonyl, decyl, undecyl, dodecyl, tetradecyl, pentadecyl, hexadecyl, ethyltetradecyl, heptadecyl, octadecyl, nonadecyl, docosyl, hexacosyl, octacosyl, triacontyl, cyclohexyl, cyclooctyl, and cyclodecyl.

Alkenyl groups suitable as the R¹ substituent of the compound of formula (I) include, for example, cis-9-hexadecenyl, all cis-7,10,13-hexadecatrienyl, cis-6-octadecenyl, trans-6-octadecenyl, cis-7-octadecenyl, cis-9-octadecenyl, trans-9-octadecenyl, cis-11-octadecenyl trans-11-octadecenyl, cis-12-octadecenyl, cis, cis-9,12-octadecedienyl, trans-9,12-octadecedienyl, all cis-6,9,12-octadecatrienyl, all cis-9,12,15-octadecatrienyl, all cis-6,9,12,15,-octadecatetraenyl, cis-11-eicosenyl, cis, cis-11,14-eicosadienyl, all cis-11,14,17-eicosatrienyl all cis-5,8,11,14-eicosatetraenyl, all cis-8,11,14,17-eicosatetraenyl, all cis-5,8,11,14,17-eicosapentaenyl, cis-13-docosenyl, cis, cis-13,16-docosadienyl, all cis-6,9,12-octadecatrienyl, all cis-7,10,13,16-docosatetraenyl, all cis-7,10,13,16,19-docosapentaenyl, all cis-4,7,10,13,16,19-docosahexaenyl, cis-15-tetracosenyl, all cis-9,12,15,18,21-tetracosapentaenyl, or all cis-6,9,12,15,18,21-tetracosahexaenyl.

In one embodiment, R¹ is linear or branched (C₄-C₃₀)alkyldienyl, more typically (C₈-C₂₄)alkyldienyl, (C₆-C₁₂)cycloalkyldienyl, linear or branched (C₄-C₃₀)alkenyldienyl, more typically (C₈-C₂₄)alkenyldienyl, (C₈-C₃₀)alkylaromaticdienyl, or (C₈-C₃₀)aralkyldienyl, and n is 2, wherein the alkenyldienyl groups may be monounsaturated or polyunsaturated.

Alkyldienyl groups suitable as the R¹ substituent of the compound of formula (I) include, for example, pentyldienyl, hexyldienyl, dimethylbutyldienyl, heptyldienyl, methylhexyldienyl, octyldienyl, ethylhexyldienyl, nonyldienyl, decyldienyl, undecyldienyl, dodecyldienyl, tetradecyldienyl, pentadecyldienyl, hexadecyldienyl, ethyltetradecyldienyl, heptadecyldienyl, octadecyldienyl, nonadecyldienyl, docosyldienyl, hexacosyldienyl, octacosyldienyl, triacontyldienyl, cyclohexyldienyl, cyclooctyldienyl, and cyclodecyldienyl.

In one embodiment, R¹ is linear or branched (C₄-C₃₀)alkyltrienyl, more typically (C₈-C₂₄)alkyltrienyl, (C₆-C₁₂)cycloalkyltrienyl, linear or branched (C₄-C₃₀)alkenyltrienyl, more typically (C₈-C₂₄)alkenyltrienyl, (C₈-C₃₀)alkylaromatictrienyl, or (C₈-C₃₀)aralkyltrienyl, and n is 3, wherein the alkenyltrienyl groups may be monounsaturated or polyunsaturated.

Alkyltrienyl groups suitable as the R¹ substituent of the compound of formula (I) include, for example, pentyltrienyl, hexyltrienyl, dimethylbutyltrienyl, heptyltrienyl, methylhexyltrienyl, octyltrienyl, ethylhexyltrienyl, nonyltrienyl, decyltrienyl, undecyltrienyl, dodecyltrienyl, tetradecyltrienyl, pentadecyltrienyl, hexadecyltrienyl, ethyltetradecyltrienyl, heptadecyltrienyl, octadecyltrienyl, nonadecyltrienyl, docosyltrienyl, hexacosyltrienyl, octacosyltrienyl, triacontyltrienyl, cyclohexyltrienyl, cyclooctyltrienyl, and cyclodecyltrienyl.

Suitable fatty alcohol drift control agent include, for example, (C₄-C₃₀)alkanols and (C₄-C₃₀)alkyl polyols, such as butanol, hexanol, 2-ethyl hexanol, octanol, nonanol, decanol, undecanol, dodecanol, tetradecanol, pentadecanol, hexadecanol, heptadecanol, octadecanol, nonadecanol, docosanol, hexacosenol, octacosenol, and triacontanol, isobutanol, sec-butanol, methylpentanol, ethylhexanol, isostearyl alcohol, isotridecanol, and methylheptadecanol, cyclohexanol, cyclooctanol, cyclodecanol, dodecanediol, cyclododecanediol, dodecylene glycol, octadecylene glycol, and (C₄-C₃₀)alkenols, such as myristoleyl alcohol, palmitoleyl alcohol, elaidyl alcohol, oleyl alcohol, linoleyl alcohol, linolenyl alcohol, eladiolinoleyl alcohol, erucyl alcohol, docosenoic alcohol, and docosahexenoic alcohol, cyclic (C₅-C₂₄)alkenols, such as terpineol, geraniol, arbanol, nopol, and menthol, (C₇-C₃₀)alkylaromatic alcohols, such as dodecylphenol, octylphenol, nonylphenol, tocopherol and thymol (C₇-C₃₀)aralkanols, such as benzyl alcohol, phenylethanol and phenylhexanol, as well as mixtures thereof.

In one embodiment, the adjuvant, concentrated pesticide composition and end use pesticide composition may each further comprise one or more hydrotropes. As used herein the term “hydrotrope” means an amphiphilic compound that does not form micelles below 0.5 wt % in aqueous solutions the presence of which in an aqueous solution tends to solubilize hydrophobic compounds in the aqueous solution, and includes, for example, alkylaromatic sulfonate salts, such as sodium xylene sulfonate and sodium toluene sulfonate, as well as alkyl phosphate esters, alkyaryl phosphate esters, phosphate polyether esters, and salts thereof, such as potassium laureth phosphate, phenol ethoxy phosphate, and alkylene glycols and polyalkylene glycols, such as propylene glycols, polyethylene glycols. The addition of a hydrotrope to the composition of the present invention typically increases the solubility of the fatty alcohol drift control agent in the aqueous medium and thus provide an opportunity to selectively adjust such solubility.

In one embodiment, the adjuvant, pesticide concentrate, and end use pesticide compositions of the present invention may each comprise one or more surfactants other than any hydrotrope component. Suitable surfactants include anionic surfactants, cationic surfactants, amphoteric/zwitterionic surfactants, nonionic surfactants, and mixtures thereof. Suitable anionic surfactants include alkyl sulfate surfactants, such as ammonium lauryl sulfate, and alkylaromatic sulfonate surfactants, such as dodecylbenzene sulfonate. Suitable cationic surfactants include alkoxylated amine surfactants such as ethoxylated tallow amine acetate, and quaternary ammonium surfactants, such as stearyl dimethyl benzyl ammonium chloride. Suitable amphoteric surfactants include alkylamphocetate surfactants such as cocoamphoacetate. Suitable zwitterionic surfactants include alkyl betaine surfactants such as lauryldimethylbetaine, and cocoamidopropylbetaine. Suitable nonionic surfactants include sorbitan ester surfactants, alkoxylated sorbitan ester surfactants, alcohol alkoxylate surfactants, alkylaromatic alkoxylate surfactants, glycoside surfactants, and ethylene oxide/propylene oxide block copolymer surfactants.

In one embodiment, the adjuvant composition comprises up to about 99.95 pbw, more typically from about 80 to about 99.5 pbw, of the liquid medium per 100 pbw of the adjuvant composition.

In one embodiment, the adjuvant composition according to the present invention comprises, based on 100 parts by weight of the adjuvant composition:

from 0.05 to 99.9 pbw, more typically from 0.5 to 80 pbw, more typically from 0.5 to 60 pbw, more typically from 0.5 to 40 pbw, more typically from 0.5 to 20 pbw, and even more typically from 0.5 to 10 pbw of the fatty alcohol drift control agent,

from 0.1 to 99.95 pbw, more typically from 20 to 99.5 pbw, more typically from 40 to 99.5 pbw, more typically from 60 to 99.5 pbw, more typically from 80 to 99.5 pbw, and even more typically from 90 to 99.5 pbw of a liquid medium,

optionally, one or more hydrotropes, and

optionally, one or more surfactants.

In one embodiment, the adjuvant composition of the present invention comprises up to about 99.9 pbw, more typically from about 1 to about 30 pbw, of one or more surfactants per 100 pbw of the adjuvant composition.

In one embodiment, the adjuvant composition according to the present invention comprises, based on 100 parts by weight of the adjuvant composition:

from 0.1 to 99.9 pbw, more typically from 70 to 99 pbw, even more typically from 90 to 98 pbw of the fatty alcohol drift control agent,

from 0.1 to 99.9 pbw, more typically from 1 to 30 pbw, and even more typically from 2 to 10 pbw of one or more surfactants,

optionally, a liquid medium, and

optionally, one or more hydrotropes.

In one embodiment, the adjuvant composition of the present invention comprises up to about 99.9 pbw, more typically from about 10 to about 50 pbw, of one or more hydrotropes per 100 pbw of the adjuvant composition.

In one embodiment, the adjuvant composition according to the present invention comprises, based on 100 parts by weight of the adjuvant composition:

from 0.1 to 99.9 pbw, more typically from 50 to 90 pbw, even more typically from 90 to 98 pbw of the fatty alcohol drift control agent,

up to about 99.9 pbw, more typically from about 10 to about 50 pbw, of one or more hydrotropes,

optionally, a liquid medium, and

optionally, one or more surfactants.

In one embodiment, the present invention is directed to a method for controlling a target pest, comprising:
(a) mixing an adjuvant composition that comprises at least one fatty alcohol having a solubility in water of less than 10 percent by weight with a pesticide and an aqueous diluent, wherein the aqueous diluent is a liquid medium comprising water and more typically is water, to form the end use pesticide composition that comprises an amount of the at least one fatty alcohol that is effective, when the end use pesticide composition is spray applied, to reduce spray drift of the spray applied end use pesticide composition compared to an analogous spray applied pesticide composition that lacks the at least one fatty alcohol, and
(b) spray applying the end use pesticide composition to the target pest and/or to the environment of the target pest.

Suitable pesticides are biologically active compounds used to control agricultural pests and include, for example, herbicides, plant growth regulators, crop dessicants, fungicides, bacteriocides, bacteriostats, insecticides, and insect repellants, as well as their water soluble salts and esters. Suitable pesticides include, for example, aryloxyphenoxy-propionate herbicides, such as haloxyfop, cyhalofop, and quizalofop, triazine herbicides such as metribuzin, hexaxinone, or atrazine; sulfonylurea herbicides such as chlorsulfuron; uracils such as lenacil, bromacil, or terbacil; urea herbicides such as linuron, diuron, siduron, or neburon; acetanilide herbicides such as alachlor, or metolachlor; thiocarbamate herbicides such as benthiocarb, triallate; oxadiazolone herbicides such as oxadiazon; isoxazolidone herbicides, phenoxy carboxylic acid herbicides such as dichlorophenoxyacetic acid (“2,4-D”), dichlorophenoxybutanoic acid (“2,4-DB”), 2-methyl-4-chlorophenoxyacetic acid (“MCPA”), 4-(4-chloro-2-methylphenoxy)butanoic acid (“MCPB”), dichlorprop, and mecoprop, diphenyl ether herbicides such as fluazifop, acifluorfen, bifenox, or oxyfluorfen; dinitro aniline herbicides such as trifluralin; organophosphonate herbicides such as glufosinate salts and esters and glyphosate salts and esters; dihalobenzonitrile herbicides such as bromoxynil, or ioxynil, benzoic acid herbicides such as dicamba, dipyridilium herbicides such as paraquat, and pyridine and pyridineoxy carboxylic acid herbicides such as clopyralid, fluroxypyr, picloram, triclopyr, and aminopyralid. Suitable fungicides include, for example, nitrilo oxime fungicides such as cymoxanil; imidazole fungicides such as benomyl, carbendazim, or thiophanate-methyl; triazole fungicides such as triadimefon; sulfenamide fungicides, such as captan; dithio-carbamate fungicides such as maneb, mancozeb, or thiram; chloronated aromatic fungicides such as chloroneb; dichloro aniline fungicides such as iprodione, strobilurin fungicides such as kresoxim-methyl, trifloxystrobin or azoxystrobin; chlorothalonil; copper salt fungicides such as copper oxychloride; sulfur; phenylamides; and acylamino fungicides such as metalaxyl or mefenoxam. Suitable insecticides, include, for example, carbamate insecticides, such as methomyl, carbaryl, carbofuran, or aldicarb; organo thiophosphate insecticides such as EPN, isofenphos, isoxathion, chlorpyrifos, or chlormephos; organophosphate insecticides such as terbufos, monocrotophos, or terachlorvinphos; perchlorinated organic insecticides such as methoxychlor; synthetic pyrethroid insecticides such as fenvalerate, abamectin or emamectin benzoate, neonicotinoide insecticides such as thiamethoxam or imidacloprid; pyrethroid insecticides such as lambda-cyhalothrin, cypermethrin or bifenthrin, and oxadiazine insecticides such as indoxacarb, imidachlopryd, or fipronil. Suitable miticides include, for example, propynyl sulfite miticides such as propargite; triazapentadiene miticides such as amitraz; chlorinated aromatic miticides such as chlorobenzilate, or tetradifan; and dinitrophenol miticides such as binapacryl. Suitable nematicides include carbamate nematicides, such as oxamyl.

Pesticide compounds are, in general, referred herein to by the names assigned by the International Organization for Standardization (ISO). ISO common names may be cross-referenced to International Union of Pure and Applied Chemistry (“IUPAC”) and Chemical Abstracts Service (“CAS”) names through a number of sources.

In one embodiment, the pesticide comprises one or more compounds selected from herbicides, plant growth regulators, crop dessicants, fungicides, bacteriocides, bacteriostats, insecticides, miticides, nematocides, insect repellants, and mixtures thereof.

In one embodiment, the pesticide is an herbicide and the pesticide composition is an herbicide composition.

In one embodiment, the herbicide composition comprises one or more herbicide compounds selected from glyphosate, water soluble glyphosate salts, water soluble glyphosate esters, and mixtures thereof, more typically selected from the sodium salt of glyphosate, the potassium salt of glyphosate, the ammonium salt of glyphosate, the dimethyl ammonium salt of glyphosate, the isopropyl amine salt of glyphosate, the trimethyl ammonium salt of glyphosate, and mixtures thereof.

In one embodiment, the pesticide composition comprises one or more auxinic herbicides, more typically, one or more auxinic herbicides selected from clopyralid, triclopyr, 2,4-D, 2,4-DB, MCPA, MCPB, dicamba, aminopyralid and picloram, and their respective water soluble salts and esters.

In one embodiment, the pesticide comprises one or more herbicide compounds selected from glyphosate, clopyralid, triclopyr, 2,4-D, 2,4-DB, MCPA, MCPB, dicamba, aminopyralid and picloram, their respective water soluble salts and esters, and mixtures thereof, more typically a mixture of water soluble salts of glyphosate and clopyralid, triclopyr, 2,4-D, 2,4-DB, MCPA, MCPB, dicamba, aminopyralid or picloram, even more typically, a mixture of water soluble salts of glyphosate and triclopyr, 2,4-D, or dicamba.

In one embodiment the water soluble salts of glyphosate, clopyralid, triclopyr, 2,4-D, 2,4-DB, MCPA, MCPB, dicamba, aminopyralid and/or picloram comprise a cation selected from dimethyl ammonium, isopropyl ammonium, diethyl ammonium, triethylammonium, monoethanol ammonium, diethanol ammonium, triethanol ammonium, dimethylethanol ammonium, diethyleneglycol ammonium, triisopropyl ammonium, tetraethylammonium, and choline cations.

In one embodiment, the pesticide is a mixture comprising glyphosate or a water soluble salt or ester of glyphosate and one or more auxinic herbicides, more typically one or more auxinic herbicides selected from clopyralid, triclopyr, 2,4-D, 2,4-DB, MCPA, MCPB, dicamba, aminopyralid and picloram, and their respective water soluble salts and esters.

In one embodiment, the concentrated pesticide composition of the present invention comprises, based on 100 pbw of the pesticide composition, from about 1 pbw, more typically from about 30 pbw, and even more typically from about 40 pbw, to about 65 pbw, more typically about 60 pbw, and even more typically about 55 pbw, of the one or more pesticide compounds.

In one embodiment, the concentrated pesticide composition according to the present invention comprises, based on 100 parts by weight of the concentrated pesticide composition:

from about 1 pbw to 65, more typically from 30 pbw to 60 pbw, and even more typically from 40 pbw to 55 pbw, of one or more pesticide compounds,

from 5 to 98.95 pbw, more typically from 20 to 69.5 pbw, and even more typically from 35 to 59.5 pbw of the liquid medium,

from 0.05 to 30 pbw, more typically from 0.5 to 20 pbw, even more typically from 0.5 to 10 pbw fatty alcohol drift control agent,

optionally one or more hydrotropes, and

optionally, one or more surfactants.

If included, the optional hydrotrope component of the concentrated pesticide composition is typically present in an amount of up to about 25 pbw, more typically from about 2 to about 10 pbw, of the one or more hydrotropes per 100 pbw of the concentrated pesticide composition.

If included, the optional surfactant component of the concentrated pesticide composition is typically present in an amount of up to about 15 pbw, more typically from about 0.1 to about 2 pbw, of the one or more surfactants per 100 pbw of the concentrated pesticide composition.

In one embodiment, the present invention is directed to a method for controlling a target pest, comprising:
(a) providing a concentrated pesticide composition according to the present invention,
(b) diluting the concentrated pesticide composition with an aqueous diluent, wherein the aqueous diluent is a liquid medium comprising water and more typically is water, to form an end use pesticide composition that comprises the at least one fatty alcohol having a solubility in water of less than 10 percent by weight in an amount that is effective, when the end use pesticide composition is spray applied, to reduce spray drift of the spray applied end use pesticide composition compared to an analogous spray applied pesticide composition that lacks the at least one fatty alcohol, and
(c) spray applying the end use pesticide composition to the target pest and/or to the environment of the target pest.

Suitable aqueous diluents comprise water and may optionally further comprise one or more water miscible organic liquids, such as, for example, (C₁-C₃)alkanols, for example, methanol, ethanol, or propanol, (C₁-C₃)glycols, for example, ethylene glycol, or propylene glycol, and/or alkylether diols, for example, ethylene glycol monoethyl ether, propylene glycol monoethyl ether and diethylene glycol monomethyl ether. Most typically, the aqueous diluent is water.

In one embodiment, the end use pesticide composition of the present invention is made by combining the adjuvant composition of the present invention, a pesticide, and an aqueous medium, typically water.

In one embodiment, the end use pesticide composition of the present invention is made by diluting the concentrated pesticide composition of the present invention with aqueous medium, typically water, typically with from 1 to 10,000 gm of the aqueous medium per 1 gm of concentrated pesticide composition.

In one embodiment, the end use pesticide composition of the present invention comprises, based on 100 pbw of the end use pesticide composition,

an aqueous medium,

from greater than 0 to about 20 pbw of the one or more pesticide compounds,

from greater than 0, more typically from 0.01 pbw, even more typically from 0.05 pbw, and still more typically from 0.1 pbw of the fatty alcohol drift control agent to 10 pbw, more typically to 2 pbw, even more typically to 0.5 pbw of the fatty alcohol drift control agent,

optionally one or more hydrotropes, and

optionally, one or more surfactants.

If included, the optional hydrotrope component of the end use pesticide composition is typically present in an amount of up to about 5 pbw, more typically from about 0.05 to about 0.25 pbw, of the one or more hydrotropes per 100 pbw of the end use pesticide composition.

In one embodiment, the present invention is directed to a method for controlling a target pest, comprising spray applying an end use pesticide composition according to the present invention to a target pest and/or to the environment of the target pest, wherein the spray applied end use pesticide composition according to the present invention exhibits reduced spray drift compared to an analogous spray applied end use pesticide composition that lacks the at least one fatty alcohol component of the end use pesticide composition according to the present invention.

If included, the optional surfactant component of the end use pesticide composition is typically present in an amount of up to about 3 pbw, more typically from about 0.01 to about 0.1 pbw, of the one or more surfactants per 100 pbw of the end use pesticide composition.

In one embodiment, the amount of fatty alcohol drift control agent present in the end use pesticide composition is greater than the solubility limit of the fatty alcohol drift control agent in the end use pesticide composition.

In one embodiment, the adjuvant composition, concentrated pesticide composition and/or end use pesticide composition further comprises a fertilizer. Such fertilizers can provide the primary nutrients of nitrogen, phosphorus and/or potassium such as urea ammonium nitrate (30-0-0), 10-34-0, secondary nutrients sulfur, calcium, magnesium such as ammonium thiosulfate 12-0-0-26S, micronutrient fertilizers containing zinc, iron, molybdenum, copper, boron, chlorine, magnesium, for example, 0-0-13%-S; 3%-Zn; 2%-Fe; 2%-Mn and mixtures thereof. In one embodiment, the end use pesticide composition comprises from about 85 to about 99 pbw, more typically from about 90 to about 99 pbw, and even more typically from about 93 to about 99 pbw, of a mixture of fertilizer and water.

In one embodiment, the concentrated pesticide composition and/or end use pesticide composition of the present invention further comprises one or more water conditioners, such as for example, chelating agents, such as ethylenediamine tetraacetic acid, complexing agents such as ammonium sulfate, and pH adjusting agents, such as citric acid and polyacrylic acid or other ingredients, such as for example, one or more thickeners, such as polysaccharide thickeners, and polyacrylamide thickeners, as well as dyes, stabilizers, fragrances, antifoams, spreaders, and freeze point depressants.

In one embodiment, the end use pesticide composition of the present invention comprises, based on 100 pbw of such composition, from about 0.1 to about 3 pbw, more typically from about 0.7 to about 2.5 pbw, of one or more water conditioners, typically ammonium sulfate.

In one embodiment, the end use pesticide composition of the present invention is applied to foliage of one or more target plants at a rate, expressed in terms of the above described concentrated pesticide composition embodiment of the pesticide composition of the present invention, of from about 0.01 pint, more typically about 0.5 pint, to about 20 pints, even more typically from about 1 pint to about 4 pints per acre.

In one embodiment, the end use pesticide composition of the present invention is spray applied, typically via conventional spray apparatus, to foliage of one or more target plants present on an area of ground at a rate of from about 1 gallon to about 100 gallons, more typically about 3 gallons to 20 gallons, of the end use pesticide composition per acre of such area of ground.

In one embodiment, the spray applied end use pesticide composition comprising the fatty alcohol drift control agent exhibits a droplet size distribution wherein the volume percentage of droplets having a droplet size of less than 150 μm is reduced compared to an analogous spray applied end use pesticide composition that lacks the fatty alcohol drift control agent, when the compositions are each spray applied under the same conditions. In one embodiment, volume percentage of droplets having a droplet size of less than 150 μm in the spray applied end use pesticide composition comprising the fatty alcohol drift control agent at least 5%, or by at least 10%, or by at least 20%, or by at least 25%, smaller than volume percentage of droplets having a droplet size of less than 150 μm in the spray applied end use pesticide composition lacking the fatty alcohol drift control agent, when the compositions are each spray applied through a TeeJet XR8002 flat fan nozzle at a pressure of 40 pounds per square inch (“psi”), and wherein the droplet distribution is measured at 30 centimeters below the nozzle tip.

The concentrated pesticide composition of the present invention exhibits good stability and handling properties, including low viscosity, and can be readily diluted with water to form efficacious aqueous pesticide compositions that may be spray applied to target pests and/or the environment of the target pests.

In one embodiment, the end use composition comprises a herbicidally effective amount of pesticide that is effective to control one or more target plant species of one or more of the following genera: Abutilon, Amaranthus, Artemisia, Asclepias, Avena, Axonopus, Borreria, Brachiaria, Brassica, Bromus, Chenopodium, Cirsium, Commelina, Convolvulus, Cynodon, Cyperus, Digitaria, Echinochloa, Eleusine, Elymus, Equisetum, Erodium, Helianthus, Imperata, Ipomoea, Kochia, Lolium, Malva, Oryza, Ottochloa, Panicum, Paspalum, Phalaris, Phragmites, Polygonum, Portulaca, Pteridium, Pueraria, Rubus, Salsola, Setaria, Sida, Sinapis, Sorghum, Triticum, Typha, Ulex, Xanthium and Zea, including annual broadleaf species such as, for example, velvetleaf (Abutilon theophrasti), pigweed (Amaranthus spp.), buttonweed (Borreria spp.), oilseed rape, canola, indian mustard, etc. (Brassica spp.), commelina (Commelina spp.), filaree (Erodium spp.), sunflower (Helianthus spp.), morningglory (Ipomoea spp.), kochia (Kochia scoparia), mallow (Malva spp.), wild buckwheat, smartweed, etc. (Polygonum spp.), purslane (Portulaca spp.), russian thistle (Salsola spp.), sida (Sida spp.), wild mustard (Sinapis arvensis) and cocklebur (Xanthium spp.), annual narrowleaf species such as for example, wild oat (Avena fatua), carpetgrass (Axonopus spp.), downy brome (Bromus tectorum), crabgrass (Digitaria spp.), barnyardgrass (Echinochloa Crus-Galli), goosegrass (Eleusine indica), annual ryegrass (Lolium multiflorum), rice (Oryza sativa), ottochloa (Ottochloa nodosa), bahiagrass (Paspalum notatum), canarygrass (Phalaris spp.), foxtail (Setaria spp.), wheat (Triticum aestivum) and corn (Zea mays), perennial broadleaf species such as, for example, mugwort (Artemisia spp.), milkweed (Asclepias spp.), canada thistle (Cirsium arvense), field bindweed (Convolvulus arvensis) and kudzu (Pueraria spp.), perennial narrowleaf species such as for example, brachiaria (Brachiaria spp.), bermudagrass (Cynodon dactylon), yellow nutsedge (Cyperus esculentus), purple nutsedge (C. rotundus), quackgrass (Elymus repens), lalang (Imperata cylindrica), perennial ryegrass (Lolium perenne), guineagrass (Panicum maximum), dallisgrass (Paspalum dilatatum), reed (Phragmites spp.), johnsongrass (Sorghum halepense) and cattail (Typha spp.), and other perennial species such as, for example, horsetail (Equisetum spp.), bracken (Pteridium aquilinum), blackberry (Rubus spp.) and gorse (Ulex europaeus).

The fatty alcohol drift control agent of the present invention can also be used as an anti-misting or anti-drift additive in aqueous spray applied compositions other than spray applied end use pesticide compositions, such as, for example, personal care compositions, home care compositions, industrial spray coatings, ink jet printing inks, pressure washing compositions, spray drying applications, and fire extinguishing compositions.

### Examples 1-4 and Comparative Examples C1-C2

The compositions of formulations A, B, and C are shown in Table I and were prepared as follows. Composition A was made by mixing a fatty alcohol (lauryl alcohol, “Alcohol 1”) and a hydrotrope (sodium xylene sulfonate, available from Sigma Aldrich as 40 wt % aqueous solution). Alcohol 1 is insoluble in water and sodium xylene sulfonate helped solubilize it in water. The resultant mixture was a clear homogeneous liquid. Composition B was made by mixing an aqueous herbicide (Roundup Powermax™ herbicide (aqueous 48.7% potassium glyphosate, Monsanto)) and lauryl alcohol. Composition C was made by mixing Roundup Powermax™ herbicide and a fatty alcohol (a mixture of C₁₄-C₂₀ saturated and unsaturated alcohols (“Alcohol 2”)). Both compositions B and C were sufficiently mixed to make sure the resultant mixture was homogenous and no insoluble material was visible.

TABLE I
Composition of Formulations A, B and C

| | Formulation | | |
|---|---|---|---|
| | A | B | C |
| Component | (wt %) | (wt %) | (wt %) |
| Alcohol 1 | 5 | 10 | — |
| Alcohol 2 | — | — | 10 |
| Sodium Xylene Sulfonate, as 40% | 95 | — | — |
| solution in water | | | |
| Potassium glyphosate herbicide | — | 90 | 90 |
| (Roundup Powermax ™ herbicide, | | | |
| Monsanto) | | | |

Spray compositions of examples 1 to 4 were prepared by diluting compositions A, B and C in distilled water. Each component of examples 1 to 4 and their composition is listed in Table II. Table II also summarizes the composition of comparative example C1 and C2.

TABLE II
Compositions of Spray solutions

| | Example No. | | | | | |
|---|---|---|---|---|---|---|
| | Ex 1 | Ex 2 | Ex 3 | Ex 4 | CEx C1 | CEx C2 |
| | (wt | (wt | (wt | (wt | (wt | (wt |
| Component | %) | %) | %) | %) | %) | %) |
| Water | 99.0 | 99.0 | 97.0 | 97.0 | 100 | 97.0 |
| Potassium glyphosate | — | 0.9 | 2.7 | 2.7 | — | 3.0 |
| herbicide (Roundup | | | | | | |
| Weathermax ™ | | | | | | |
| herbicide, Monsanto) | | | | | | |
| Alcohol 1 | 0.05 | 0.1 | 0.3 | — | — | — |
| Alcohol 2 | — | — | — | 0.3 | — | — |
| Sodium Xylene | 0.95 | — | — | — | — | — |
| Sulfonate, as 40% | | | | | | |
| solution in water | | | | | | |

Samples of all compositions (Examples 1-4 and Comparative Examples C1 and C2) were sprayed through a TeeJet XR8002 flat fan nozzle at a pressure of 40 pounds per square inch (“psi”) and the droplet size distribution was measured perpendicular to the plane of spray pattern and 30 centimeters (“cm”) below the nozzle tip. The spray solutions of composition of Examples 1-3 were first screened through a 100 micrometer (“μm”) size sieve to extract insoluble material from the solution. A HELOS VARIO particle size analyzer (Sympatec) was used to measure droplets generated in spray compositions using a R7 lens (which has measurement range between 18 and 3500 μm). The results for volume mean diameter (“VMD”), expressed in micrometers, and volume percentage of driftable fines (droplets below 150 μm, expressed as volume %) for each composition are given in Table III below.

TABLE III
Spray characteristics of compositions

| | VMD | Droplet of size <150 μm |
|---|---|---|
| EX # | (μm) | (Volume %) |
| CEX C1 | 176 | 50.8 |
| CEX C2 | 161 | 56.6 |
| EX 1 | 214 | 29.2 |
| EX 2 | 202 | 38.0 |
| EX 3 | 200 | 38.4 |
| EX 4 | 212 | 33.2 |

As seen from the results, the spray composition of Example 1 exhibited increased volume mean diameter and decreased volume of driftable fines compared to the spray composition of Comparative Example C2, and each of the spray compositions of Examples 2-4 exhibited increased volume mean diameter and decreased volume of driftable fines compared to the spray composition of Comparative Example C2.

### Example 5 and Comparative Example C5

The compositions of concentrated pesticide formulations D, E, F, G, and H were made by mixing an aqueous herbicide (aqueous concentrate of 2,4-D choline salt) with a fatty alcohol selected from Alcohol 2, as described above, a mixture of C₁₁-C₁₄ alcohols comprising a C₁₃ branched alcohol (“Alcohol 3”), a mixture of C₁₀-C₁₆ linear alcohols (“Alcohol 4”), and a mixture of C₁₀-C₁₈ linear and branched alcohols (“Alcohol 5”), in the amounts set forth in the Table IV below. Each mixture was stirred to mix the composition. The resultant compositions were low viscosity solutions. Small samples (20 milliLiters (“mL”) in a glass vial) of the compositions D to H were observed for storage stability at 54° C., room temperature, 4° C. and −16° C. A summary of the storage stability for compositions D to H is described in Table IV. All compositions except E froze at −16° C., but returned to a flowable state once allowed to thaw at room temperature.

TABLE IV
Composition of Formulations D to H

| | Formulation | | | | |
|---|---|---|---|---|---|
| | D | E | F | G | H |
| Component | (wt %) | (wt %) | (wt %) | (wt %) | (wt %) |
| Alcohol 2 | 6 | — | — | — | 3 |
| Alcohol 3 | — | 6 | — | — | — |
| Alcohol 4 | — | — | 6 | — | — |
| Alcohol 5 | — | — | — | 6 | — |
| Aqueous 2, 4-D | 94 | 94 | 94 | 94 | 97 |
| choline salt | | | | | |
| Stability@ 54° C., | stable | stable | stable | stable | stable |
| Room temperature | | | | | |
| (2 months) | | | | | |
| Stability@ 4° C. | gel | Flowable | Flowable | Flowable | gel |
| (2 months) | | | | | |
| Stability@ −16° C. | Frozen | Flowable | Frozen | Frozen | Frozen |
| (2 months) | | | | | |

Aqueous spray compositions were made by adding 20 grams (“g”) of a respective one of formulations D-H in 980 g of water of hardness 340 parts per million (“ppm”). The composition of Comparative Example C5 contained 20 g aqueous herbicide (aqueous concentrate of 2,4-D choline salt) in 980 g water. The spray solutions were sprayed through a TeeJet XR8002 flat fan nozzle at a pressure of 40 psi and the droplet size distribution was measured perpendicular to the plane of spray pattern and 15 cm below the nozzle tip. A HELOS VARIO particle size analyzer (Sympatec) was used to measure droplets generated in spray compositions using a R7 lens. A blank aqueous solution of the 2,4-D salt was also sprayed and analyzed for droplet size for comparison purpose. The results for volume percentage of driftable fines (droplets below 150 μm, expressed as volume %) for each composition are given in Table V below. As can be seen from these results, the driftable fines are largely reduced by the spray composition containing alcohols.

TABLE V
Drift performance of Example 5 and Comparative Example C5

| | Formulation | Droplet of size <150 μm |
|---|---|---|
| Example # | (2 wt % in water) | (Volume %) |
| CEx. 5 | Aqueous 2, 4-D choline salt | 43.5 |
| Ex. 5-D | D | 21.5 |
| Ex. 5-E | E | 38.7 |
| Ex. 5-F | F | 24 |
| Ex. 5-G | G | 26.7 |
| Ex. 5-H | H | 21.5 |

### Example 6

The spray compositions of Example 6-D, 6-F and 6-H were made as follows: first 20 g solution of a pesticide concentrate (Formulation D, F or H, as described above) was added in 980 gm of water of hardness 340 ppm and then to each spray solution 20 gm of glyphosate potassium salt (Roundup Powermax™, Monsanto) was added and stirred to mix the composition. The aqueous solutions thus obtained were sprayed following the same procedure and conditions as described in Example 5 above. The results for volume percentage of driftable fines (droplets below 150 μm, expressed as volume %) for each composition are in Table VI below. As seen can be seen from these results, the addition of Glyphosate-Potassium does not significantly affect the drift performance from Example 5.

TABLE VI
Drift performance of Example 6

| | | Droplet of size <150 μm |
|---|---|---|
| Example # | Ingredients | (Volume %) |
| Ex. 6-D | D + glyphosate potassium salt | 22.7 |
| Ex. 6-F | F + glyphosate potassium salt | 25.5 |
| Ex. 6-H | H + glyphosate potassium salt | 22.5 |

### Example 7

The spray compositions of Example 7 were made and tested in a manner analogous to that described above in Example 6, except that a glyphosate dimethylamine salt was substituted for the glyphosate potassium salt used in Example 6. The volume percentage of driftable fines (droplets below 150 μm, expressed as volume %) for each of the compositions of Example 7 is shown in Table VII below.

TABLE VII
Drift performance of Example 7

| | Formulation and | Droplet of size <150 μm |
|---|---|---|
| Example # | it's wt % in water | (Volume %) |
| Ex. 7-D | D 2% + glyphosate | 22.9 |
| | dimethylamine salt | |
| Ex. 7-F | F 2% + glyphosate | 23.2 |
| | dimethylamine salt | |

### Examples 8-I and 8-J and Comparative Example C8

The compositions of formulations I and J were prepared by blending a fatty alcohol component selected from Alcohol 2, and Alcohol 3, each as described above, and one or more surfactants selected from castor oil ethoxylate (Alkamuls OR/36 (Rhodia Inc.), “Surfactant 1”), alcohol ethoxylate (Rhodasurf BC-840 (Rhodia Inc.), “Surfactant 2”), and dodecyl benzene sulfonate (Rhodacal IPAM, “Surfactant 3”), as summarized Table VIII below.

TABLE VIII
Composition of Formulations I and J

| | Formulation | |
|---|---|---|
| | I | J |
| Component | (wt %) | (wt %) |
| Alcohol 2 | 90 | — |
| Alcohol 3 | — | 94 |
| Surfactant 1 | 10 | — |
| Surfactant 2 | — | 3 |
| Surfactant 3 | — | 3 |

Aqueous spray compositions of examples 8 were prepared by diluting compositions I and J in distilled water in the amount shown in Table IX.

TABLE IX
Drift performance of Examples 8-I and 8-J and
Comparative Example C8

| | Formulation | Droplet of size <150 μm |
|---|---|---|
| Example # | (0.3 wt % in water) | (Volume %) |
| C.Ex. 8 | Water | 43.5 |
| Ex. 8-I | I | 16.7 |
| Ex. 8-J | J | 20.7 |

The aqueous solutions thus obtained were sprayed following the same procedure and conditions as described in Example 5 above. The volume percentage of driftable fines (droplets below 150 μm, expressed as volume %) for each of the compositions are shown in Table IX and X below. As seen can be seen from these results, the blend of fatty alcohol and surfactant reduces the driftable fines significantly compare to the formulations without those components.

### Example 9

Preparation of a 2,4-D choline SL formulation concentrate with fatty alcohol: To 9.0 g of an aqueous 2,4-D choline salt concentrate (538 g ae/L) was added 1.0 g of each of the hydrophobic alcohols listed in Table X. After brief agitation a clear homogeneous concentrate resulted.

### Example 10

Dilution performance of herbicide salt formulations with included fatty alcohol: Approximately 1 g of each of the concentrates of Example 9 was added to 100 ml of tap water. In all cases, a rich emulsion formed immediately when the clear, homogeneous concentrates were added to the water.

### Example 11

Spray drift reduction performance of herbicide salt formulations with included fatty alcohol: To test the spray drift reduction performance, referring to Table X, 180 g quantities of spray solution were prepared by adding each of the herbicide concentrates of Example 9 (2.2% of the total weight), Roundup PowerMax (2.3%), optionally, ammonium sulfate (2%) to tap water (balance). In all cases a rich emulsion was formed when the fatty alcohol containing concentrates were added to the water. As a control, a spray solution comprised of 2.2% Weedar 64 (2,4-D DMA), 2.3% Roundup PowerMax and tap water was prepared. The spray solutions were sprayed through a TeeJet XR8002 flat fan nozzle, the spray droplet size distribution of each of the spray solutions was measured using a Sympatec Helos laser diffraction particle analyzer and the drift potential of each of the spray solutions assessed from the percentage of driftable fines below 150 μm (volume %<150 μm). The %<150 μm value for the control was 60.8%. The %<150 μm values for each of the samples from Examples 9 are summarized in Table X. In all cases the values were significantly less than that of the control.

TABLE X
Spray Performance Summary of herbicide salt
formulations with included hydrophobic alcohol.

| | Droplet of size <150 μm | | |
|---|---|---|---|
| Formulation | (Volume %) | | |
| Herbicide Salt/Additive | Alone | PowerMax | PowerMax + AMS |
| 2, 4-D choline/No additive | 45.0 | 50 | — |
| 2, 4-D choline/nonylphenol | 37.3 | 20.6 | 22.6 |
| 2, 4-D choline/Tocopherol | — | 18.9 | — |
| 2, 4-D choline/Thymol | — | 19.4 | 20.9 |
| 2, 4-D choline/2-ethyl hexanol | 27 | 26.8 | — |
| Weedar (Control) | | 60.8 | — |

1. An adjuvant composition for modifying the spray properties of an aqueous pesticide composition, comprising:
at least one fatty alcohol having a solubility in water of less than 10 percent by weight, in an amount that is effective, when the adjuvant composition is diluted in the aqueous pesticide composition and the aqueous pesticide composition is spray applied, to reduce spray drift of the spray applied aqueous pesticide composition compared to an analogous spray applied pesticide composition that lacks the at least one fatty alcohol, and
at least one of
a liquid medium,
one or more hydrotropes, or
one or more surfactants.

2. The composition of claim 1, wherein the fatty alcohol comprises one or more fatty alcohols according to structure (I):
R¹−OH (I)
wherein:
R¹ is a (C₄-C₃₀)hydrocarbyl group or a (C₄-C₃₀)hydrocarbyl group substituted with one or more hydroxyl groups.

3. The composition of claim 2, wherein R¹ is linear or branched (C₈-C₂₄)alkyl, (C₈-C₁₂)cycloalkyl, linear or branched (C₈-C₂₄)alkenyl, (C₈-C₃₀)alkylaromatic, or (C₇-C₃₀)aralkyl, and n is 1, wherein the alkenyl groups is monounsaturated or polyunsaturated.

4. The composition of claim 3, wherein the fatty alcohol comprises one or more fatty alcohols selected from the group consisting of lauryl alcohol, a mixture of saturated and unsaturated C₁₄-C₂₀ alcohols, a mixture of C₁₁-C₁₄ alcohols that comprises a C₁₃ branched alcohol, a mixture of C₁₀-C₁₆ linear alcohols, and a mixture of C₁₀-C₁₈ linear and branched alcohols.

5. The composition of claim 3, wherein the fatty alcohol comprises one or more fatty alcohols selected from the group consisting of nonylphenol, tocopherol, thymol and 2-ethyl hexanol.

6. A method for controlling a target pest, comprising:
(a) mixing an adjuvant composition of claim 1 with a pesticide and an aqueous diluent to form the end use pesticide composition that comprises an amount of the at least one fatty alcohol that is effective, when the end use pesticide composition is spray applied, to reduce spray drift of the spray applied pesticide composition compared to an analogous spray applied pesticide composition that lacks the at least one fatty alcohol, and
(b) spray applying the end use pesticide composition to the target pest and/or to the environment of the target pest.

7. A concentrated pesticide composition, comprising:
a liquid medium,
one or more pesticide compounds, and
at least one fatty alcohol having a solubility in water of less than 10 percent by weight, in an amount that is effective, when the concentrated pesticide composition is diluted and spray applied, to reduce spray drift of the spray applied pesticide composition compared to an analogous spray applied pesticide composition that lacks the at least one fatty alcohol.

8. The composition of claim 7, wherein the pesticide compound comprises one or more herbicide compounds selected from glyphosate, clopyralid, triclopyr, 2,4-D, 2,4-DB, MCPA, MCPB, dicamba, aminopyralid and picloram, their respective water soluble salts and esters, and mixtures thereof.

9. The composition of claim 7, wherein the fatty alcohol comprises one or more fatty alcohols according to structure (I):
R¹—OH (I)
wherein:
R¹ is a (C₄-C₃₀)hydrocarbyl group or a (C₄-C₃₀)hydrocarbyl group substituted with one or more hydroxyl groups.

10. The composition of claim 9, wherein R¹ is linear or branched (C₈-C₂₄)alkyl, (C₆-C₁₂)cycloalkyl, linear or branched (C₈-C₂₄)alkenyl, (C₈-C₃₀)alkylaromatic, or (C₇-C₃₀)aralkyl, and n is 1, wherein the alkenyl groups is monounsaturated or polyunsaturated.

11. The composition of claim 10, wherein the fatty alcohol comprises one or more fatty alcohols selected from the group consisting of lauryl alcohol, a mixture of saturated and unsaturated C₁₄-C₂₀ alcohols, a mixture of C₁₁-C₁₄ alcohols that comprises a C₁₃ branched alcohol, a mixture of C₁₀-C₁₆ linear alcohols, and a mixture of C₁₀-C₁₈ linear and branched alcohols.

12. The composition of claim 10, wherein the fatty alcohol comprises one or more fatty alcohols selected from the group consisting of nonylphenol, tocopherol, thymol and 2-ethyl hexanol.

13. A method for controlling a target pest, comprising:
(a) diluting the concentrated pesticide composition of claim 7 with an aqueous diluent to form an end use pesticide composition that comprises the at least one fatty alcohol in an amount that is effective, when the end use pesticide composition is spray applied, to reduce spray drift of the spray applied end use pesticide composition compared to an analogous spray applied pesticide composition that lacks the at least one fatty alcohol, and
(b) spray applying the end use pesticide composition to the target pest and/or to the environment of the target pest.

14. An end use pesticide composition, comprising:
water,
a pesticide, and
at least one fatty alcohol having a solubility in water of less than 10 percent by weight, in an amount effective as a drift control agent.

15. The composition of claim 14, wherein the pesticide comprises one or more herbicide compounds selected from glyphosate, clopyralid, triclopyr, 2,4-D, 2,4-DB, MCPA, MCPB, dicamba, aminopyralid and picloram, their respective water soluble salts and esters, and mixtures thereof.

16. The composition of claim 14, wherein the fatty alcohol comprises one or more fatty alcohols according to structure (I):
R¹—OH (I)
wherein:
R¹ a (C₄-C₃₀)hydrocarbyl group or a (C₄-C₃₀)hydrocarbyl group substituted with one or more hydroxyl groups.

17. The composition of claim 16, wherein R¹ is linear or branched (C₈-C₂₄)alkyl, (C₆-C₁₂)cycloalkyl, linear or branched (C₈-C₂₄)alkenyl, (C₈-C₃₀)alkylaromatic, or (C₇-C₃₀)aralkyl, and n is 1, wherein the alkenyl groups is monounsaturated or polyunsaturated.

18. The composition of claim 17, wherein the fatty alcohol comprises one or more fatty alcohols selected from the group consisting of lauryl alcohol, a mixture of saturated and unsaturated C₁₄-C₂₀ alcohols, a mixture of C₁₁-C₁₄ alcohols that comprises a C₁₃ branched alcohol, a mixture of C₁₀-C₁₆ linear alcohols, and a mixture of C₁₀-C₁₈ linear and branched alcohols.

19. The composition of claim 17, wherein the fatty alcohol comprises one or more fatty alcohols selected from the group consisting of nonylphenol, tocopherol, thymol and 2-ethyl hexanol.

20. A method for controlling a target pest, comprising spray applying the end use pesticide composition of claim 14 to the target pest and/or to the environment of the target pest, wherein the spray applied end use pesticide composition exhibits reduced spray drift compared to an analogous spray applied pesticide composition that lacks the at least one fatty alcohol component of the end use pesticide composition of claim 14.

21. A method for controlling spray drift of an aqueous pesticide composition, comprising:
incorporating in the aqueous pesticide composition, in an amount effective as a drift control agent, at least one fatty alcohol having a solubility in water of less than 10 percent by weight in an amount that is effective, when the end use pesticide composition is spray applied, to reduce spray drift of the spray applied pesticide composition compared to an analogous spray applied pesticide composition that lacks the at least one fatty alcohol, and
spray applying the aqueous pesticide composition to a target pest and/or to the environment of the target pest.

22. The method of claim 21, wherein the pesticide composition comprises one or more herbicide compounds selected from glyphosate, clopyralid, triclopyr, 2,4-D, 2,4-DB, MCPA, MCPB, dicamba, aminopyralid and picloram, their respective water soluble salts and esters, and mixtures thereof.

23. The method of claim 21, wherein, the fatty alcohol comprises one or more fatty alcohols according to structure (I):
R¹—OH (I)
wherein:
R¹ is a (C₄-C₃₀)hydrocarbyl group or a (C₄-C₃₀)hydrocarbyl group substituted with one or more hydroxyl groups.

24. The method of claim 21, wherein the fatty alcohol comprises one or more fatty alcohols selected from the group consisting of lauryl alcohol, a mixture of saturated and unsaturated C₁₄-C₂₀ alcohols, a mixture of C₁₁-C₁₄ alcohols comprising a C₁₃ branched alcohol, a mixture of C₁₀-C₁₆ linear alcohols, and a mixture of C₁₀-C₁₈ linear and branched alcohols.

25. The method of claim 21, wherein the fatty alcohol comprises one or more fatty alcohols selected from the group consisting of nonylphenol, tocopherol, thymol and 2-ethyl hexanol.
